(19) United States
(12) Patent Application Publication
(10) Pub. No.: US 2006/0063527 A1
(43) Pub. Date: Mar. 23, 2006

(54) Wireless LAN system and base station therefor

(75) Inventor: Yoichi Ito, Tsurugashima-shi (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/228,019

(22) Filed: Sep. 16, 2005

(30) Foreign Application Priority Data
Sep. 17, 2004 (JP) 2004-272300

(51) Int. Cl. H04Q 7/20

(52) U.S. Cl. 455/426.2; 455/411

(57) ABSTRACT

A wireless LAN system includes a base station, a first terminal station that is permanently connected to the base station, and a second terminal station that is temporarily connected to the base station. The base station and the first terminal station perform wireless communications by using a permanent encryption key. The base station and the second terminal station perform wireless communications by using a temporary encryption key. The temporary encryption key is invalidated, for example, when a predetermined time has elapsed.

### BACKGROUND OF THE INVENTION

1. Field of the Invention

The present invention relates to a wireless local area network (LAN) system and a base station that can be used in the LAN system.

2. Description of the Related Art

Recently, data communications that use wireless LANs have become widespread. Institute of Electrical and Electronics Engineers (IEEE) 802.11 is an example of wireless LANs. Wireless terminals in a wireless LAN perform data communications between each other by forming a wireless network of electrical waves.

Each wireless terminal is provided with a wireless LAN card and an adaptor via which the wireless terminal can communicate with a wireless access point. Wireless LANs based on IEEE 802.11 standard use frequency bands of 2.4 Gigahertz and 5 Gigahertz that do not require license. Because these frequency bands do not require license, they are not as safe as the frequency bands that require license. Therefore, in the wireless LANs, measures are required to be taken to maintain security.

One approach is to use common encryption keys (common keys) such as wireless equivalent privacy (WEP) within a group of wireless terminals in a wireless LAN. Patent Application Laid-Open Nos. 2004-112225, 2004-064531, and 2001-111544 disclose the techniques of using the WEP.

Sometimes a wireless terminal in one group may be temporarily moved to another group. If a common key of the new group is set in such a wireless terminal, then when the wireless terminal is moved back to its original wireless LAN or to a different wireless LAN, the common key becomes know so that the security can not be maintained.

### SUMMARY OF THE INVENTION

It is an object of the present invention to at least solve the problems in the conventional technology.

According to one aspect of the present invention, a wireless LAN system includes a base station configured to store a first authentication information and a second authentication information; at least one first terminal station configured to store the first authentication information; and at least one second terminal station configured to store the second authentication information. The first terminal station is configured to perform wireless communications with another first terminal station via the base station based on the first authentication information, and the first terminal station and the second terminal station are configured to perform wireless communications with each other via the base station based on the second authentication information.

According to another aspect of the present invention, a wireless LAN system includes a base station configured to store a first authentication information and a second authentication information, and to transmit a third authentication information prepared by encrypting the second authentication information with the first authentication information; at least one first terminal station configured to receive and store the third authentication information; and at least one second terminal station configured to store the second authentication information. The first terminal station is configured to perform wireless communications with another first terminal station directly based on the first authentication information, and the first terminal station and the second terminal station are configured to perform wireless communications directly with each other based on the second authentication information and the third authentication information.

According to still another aspect of the present invention, a wireless LAN system includes a first terminal station configured to store a first authentication information and a second authentication information, and to transmit a third authentication information prepared by encrypting the second authentication information with the first authentication information; at least one second terminal station configured to store the second authentication information; and at least one third terminal station configured to receive and store the third authentication information. The first terminal station is configured to perform wireless communications with the third terminal station based on the first authentication information, the first terminal station and the second terminal station are configured to perform wireless communications with each other based on the second authentication information, and the second terminal station and the third terminal station are configured to perform wireless communications with each other based on the second authentication information and the third authentication information.

According to still another aspect of the present invention, a base station performs wireless communications with a plurality of terminal stations including at least one first terminal station and at least one second terminal station and includes a storing unit configured to store therein a first authentication information and a second authentication information; and a communications unit configured to perform wireless communications with the first terminal station based on the first authentication information, and to perform wireless communications with the second terminal station based on the second authentication information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a wireless LAN system according to a first embodiment of the present invention;

FIG. 2 is a detailed block diagram of a base station (access point) shown in FIG. 1;

FIG. 3 is a detailed block diagram of a terminal station shown in FIG. 1;

FIG. 4 is a flowchart of a process procedure for connecting a new terminal station to the wireless LAN system;

FIG. 5 is a flowchart of a process procedure performed by the base station when receiving a packet from the terminal station;

FIG. 6 is a flowchart of a process procedure performed by the base station when transmitting a packet to the terminal station;

FIG. 7 is a flowchart of a process procedure performed by a controller of the base station;

FIG. 8 is a continuation of the flowchart shown in FIG. 7;

FIG. 9 is a flowchart of an example of a process procedure performed by a wireless LAN system according to a second embodiment of the present invention;

FIG. 10 is a flowchart of another example of a process procedure performed by the wireless LAN system according to the second embodiment;

FIG. 11 is a flowchart of a process procedure performed by a wireless LAN system according to a third embodiment of the present invention;

FIG. 12 is a schematic of a wireless LAN system according to a fourth embodiment of the present invention; and

FIG. 13 is a schematic for explaining an operation of the wireless LAN system shown in FIG. 12.

### DETAILED DESCRIPTION OF THE PREFERRED EMBODIMENTS

Exemplary embodiments of the present invention will be explained below with reference to the accompanying drawings. The present invention is not limited by the embodiments. Constituent elements in the embodiments include ones that will readily occur to those skilled in the art or substantial equivalents thereof.

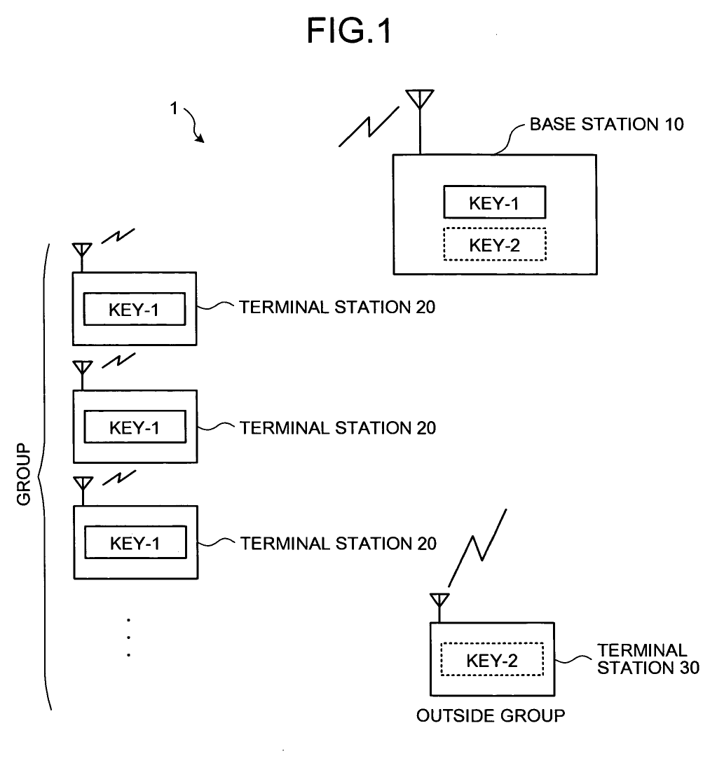

FIG. 1 is a schematic of a wireless LAN system 1 according to a first embodiment of the present invention. The wireless LAN system 1 is based on IEEE 802.11 standard. In other words, wireless terminals communicate with each other via a base station.

The wireless LAN system 1 includes a base station 10, a plurality of terminal station 20. The base station 10, which is also called an access point, is configured to relay wireless communications to the terminal stations 20. The base station 10 also authenticates the terminal stations 20. Thus, the terminal stations 20 belong to one group and they can perform communications with the base station 10. Assume a terminal station 30 that is outside of the group of the terminal stations 20 and that the terminal station 30 is to be temporarily connected to the wireless LAN system 1.

The base station 10 holds two encryption keys KEY-1 and KEY-2. The encryption key KEY-1 is a permanent key, i.e., it can be used for a long period of time unless it is intentionally modified. The encryption key KEY-1 is set in all the terminal stations 20. In other words, the encryption key KEY-1 is used in communications, authentication, and the like between the base station 10 and the terminal stations 20.

The encryption key KEY-2 is a temporary key, i.e., it is made invalid when a certain condition is satisfied. The encryption key KEY-2 is set in the terminal station 30. In other words, the encryption key KEY-1 is not set in the terminal station 30. The encryption key KEY-2 is used in communications between the base station 10 and the terminal station 30.

Although only one terminal station 30 has been shown in FIG. 1, plural terminal stations can be connected to the wireless LAN system 1. When plural terminal stations are to be connected, the same encryption key KEY-2 is set in all the terminal stations.

The temporary encryption key KEY-2 can be made invalid when, for example, a predetermined time elapses, or when the volume of communications performed by using the temporary encryption key KEY-2 reaches a predetermined value. WEP and the like used in IEEE 802.11 can be used as the permanent encryption key KEY-1 and the temporary encryption key KEY-2.

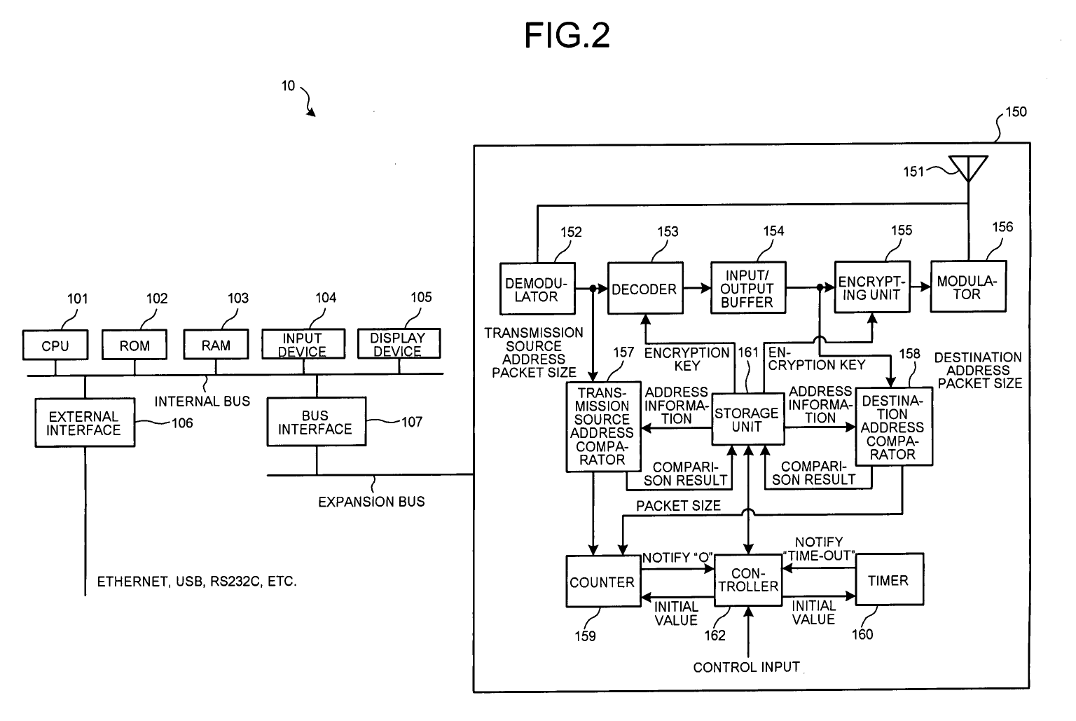

FIG. 2 is a detailed block diagram of the base station 10. The base station 10 includes a central processing unit (CPU) 101 that controls the entire device, a read only memory (ROM) 102 that stores data, programs executed by the CPU 101, and the like, a random access memory (RAM) 103 that is used as a work area of the CPU 101, an input device 104 consisting of a keyboard, a touch panel, a pointing device, and the like, a display device 105 consisting of a liquid crystal display panel, a cathode ray tube (CRT), and the like, an external interface 106 that uses Ethernet, a universal serial bus (USB), RS-232C, and the like, to connect to external devices, a bus interface 107 that uses an expansion bus to connect to a wireless LAN device 150, and the wireless LAN device 150.

The wireless LAN device 150 includes an antenna 151, a demodulator 152 that receives a packet via the antenna 151 and demodulates the packet, a decoder 153 that uses an encryption key to decode a data portion of the demodulated packet, an input/output buffer 154 that stores the packet, an encrypting unit 155 that uses an encryption key to encrypt the data portion of a transmitted packet, and a modulator 156 that modulates the packet encrypted by the encrypting unit 155 and transmits the modulated packet via the antenna 151.

The wireless LAN device 150 also includes a transmission source address comparator 157 that determines whether the transmission source address of a received packet matches an address (terminal station address of the terminal station 30 where the temporary encryption key KEY-2 is set) registered in a storage unit 161, a destination address comparator 158 that determines whether the destination address of a packet to be transmitted matches an address (terminal station address of the terminal station 30 where the temporary encryption key KEY-2 is set) registered in the storage unit 161, a counter 159 that subtracts the packet size of a transmitted or received packet from a counter value and determines whether the communication volume has reached the counter value, a timer 160 that measures the time and determines whether it has reached a timer initial value, the storage unit 161 that stores various types of data (the permanent encryption key KEY-1, the temporary encryption key KEY-2, terminal addresses, and the like), and a controller 162 that controls all parts of the wireless LAN device.

Various types of settings for the wireless LAN device 150 of the base station 10 are executed by external devices that are connected to the Ethernet, the USB, the RS-232C, and the like, via the input device 104 and the external interface 106. For example, the input device 104 or the external devices input a counter initial value for the counter 159, a timer initial value for the timer 160, setting/deletion of the permanent encryption key KEY-1, setting/deletion of the temporary encryption key KEY-2, notification of disconnection, and the like.

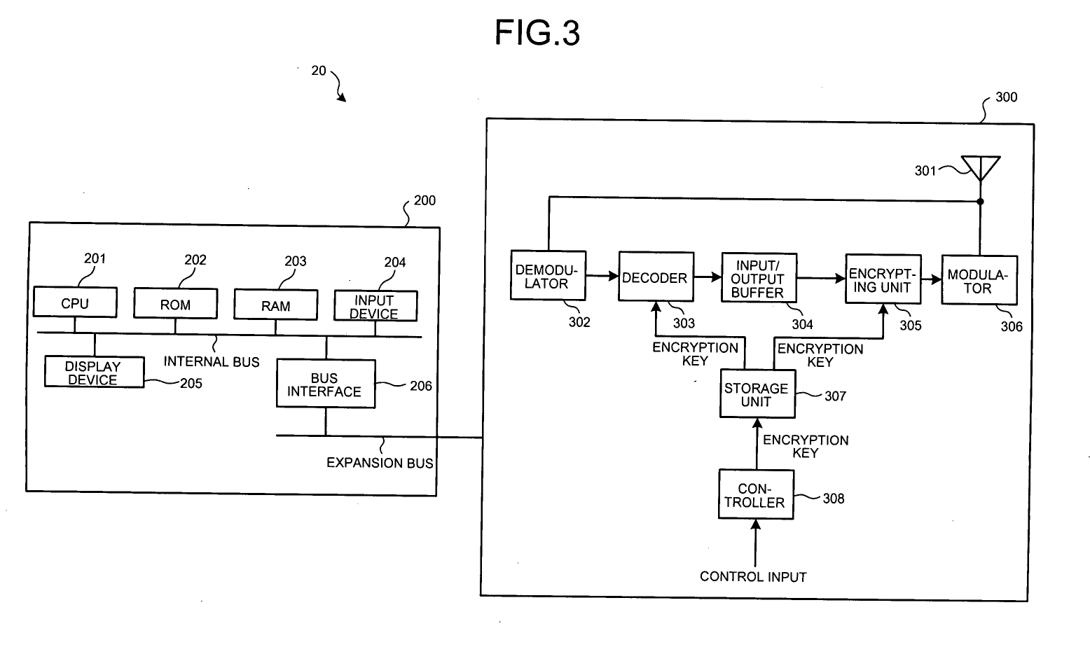

FIG. 3 is a detailed block diagram of the terminal station 20. The terminal station 30 has basically the same configuration as the terminal station 20; therefore, description thereof will be omitted. The terminal stations 20 includes a data terminal 200 such as a laptop personal computer (PC), and a wireless LAN device (for example, a wireless LAN card) 300 on which hardware and firmware, which are inserted into the data terminal 200 and control transmission or reception of radio signals and control radio signals, are mounted.

The data terminal 200 includes a CPU 201 that controls the entire device, a ROM 202 that stores programs executed by the CPU 201, data, and the like, a RAM 203 that is used as a work area of the CPU 201, an input device 204 consisting of a keyboard, a touch panel, a pointing device, and the like, a display device 205 consisting of a liquid crystal display panel, a CRT, and the like, and a bus interface 206 that uses an expansion bus to connect to the wireless LAN device 300.

The wireless LAN device 300 includes an antenna 301, a demodulator 302 that receives a packet via the antenna 301 and demodulates the packet, a decoder 303 that uses an encryption key to decode a data portion of the demodulated packet, an input/output buffer 304 that stores the packet, an encrypting unit 305 that uses an encryption key to encrypt the data portion of a transmitted packet, a modulator 306 that modulates the packet encrypted by the encrypting unit 305 and transmits the modulated packet via the antenna 301, a storage unit 307 that stores various types of data (for example, the permanent encryption key KEY-1 for the terminal station 20 and the temporary encryption key KEY-2 for the terminal station 30), and a controller 308 that controls all parts of the wireless LAN device 300. Various types of settings for the wireless LAN device 300 of the terminal stations 20 and 30 are executed by the input device 204.

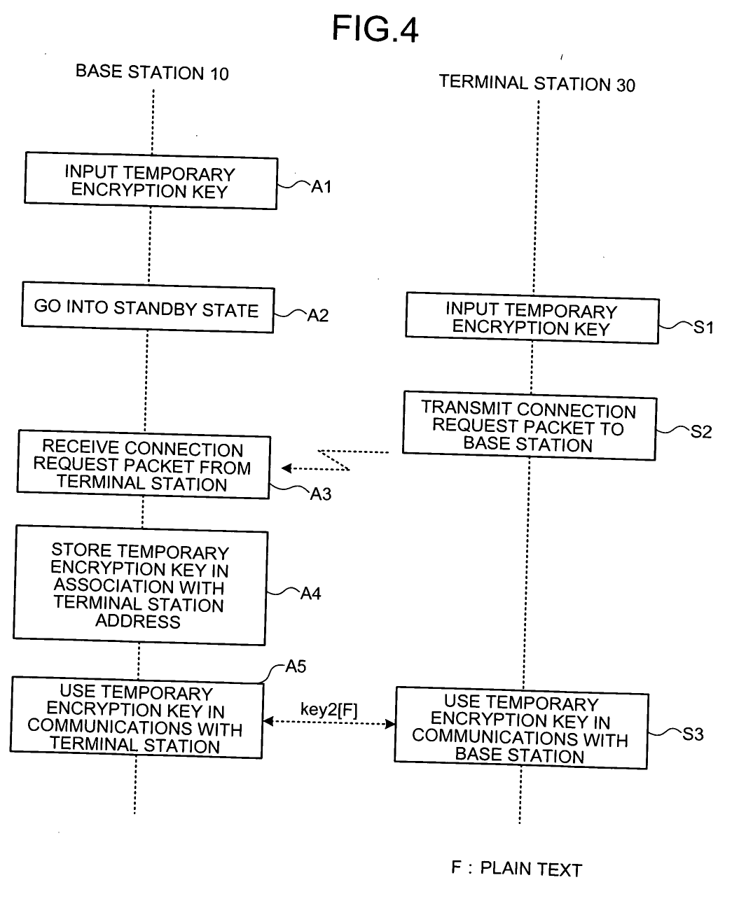

FIG. 4 is a flowchart of a process procedure when connecting the terminal station 30 to the wireless LAN system 1. At step A1, in the base station 10, the temporary encryption key KEY-2 is input by using the input device 104. Instead of inputting the temporary encryption key KEY-2 through the input device 104, the external device connected to the external interface 106 can be used to input the temporary encryption key KEY-2. The temporary encryption key KEY-2 is stored in the storage unit 161 of the wireless LAN device 150. Thus, the base station 10 becomes a standby state for connecting the terminal station 30 that uses the temporary encryption key KEY-2 (step A2).

On the other hand, at step S1, in the terminal station 30, the temporary encryption key KEY-2 is input by using the input device 204. The input temporary encryption key KEY-2 is stored in the storage unit 307 of the wireless LAN device 300. The terminal station 30 transmits a connection request packet to the base station 10 (step S2).

Upon receiving the connection request packet from the terminal station 30 (step A3), the base station 10 stores a terminal station address obtained from the received connection request packet in the storage unit 161 in association with the temporary encryption key KEY-2 (step A4). This temporary encryption key KEY-2 is subsequently used in communications between the terminal station 30 and the base station 10 (steps A5 and S3).

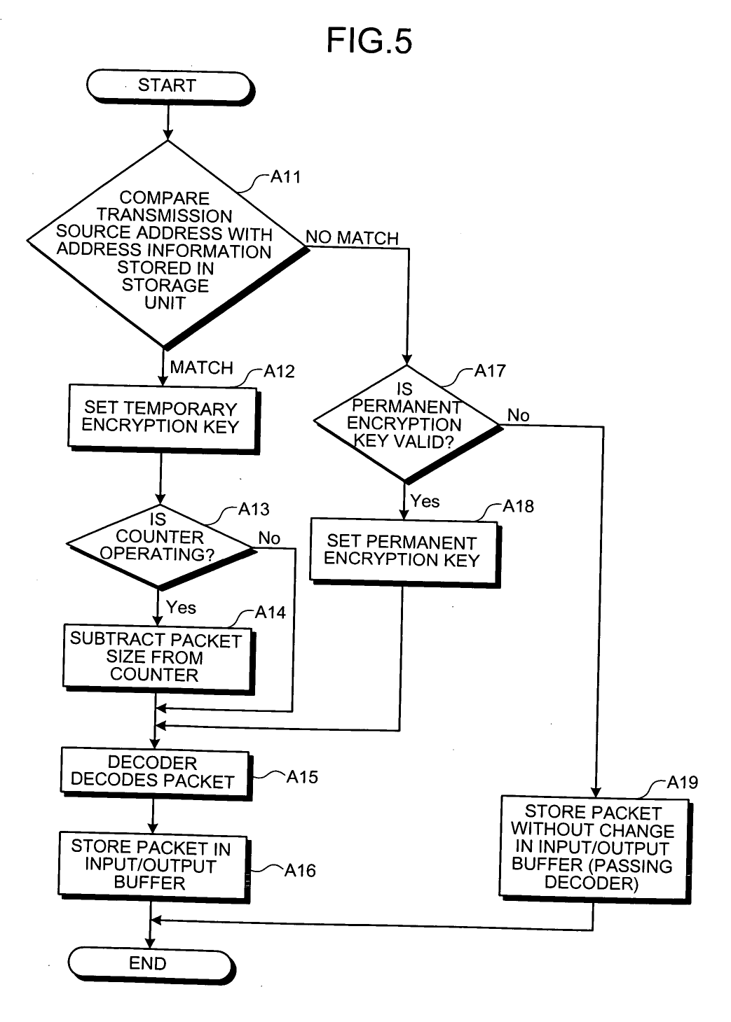

FIG. 5 is a flowchart of a process procedure performed by the base station 10 when receiving a packet from the terminal station 20 or the terminal station 30. The operation when the base station 10 receives a packet from the terminal station 20 or the terminal station 30 will be explained with reference to FIG. 5.

In FIG. 5, when the base station 10 receives a packet via the antenna 151, the demodulator 152 demodulates the packet and the transmission source address comparator 157 determines whether the transmission source address of the demodulated packet matches the address (terminal station address) that is stored in association with the temporary encryption key KEY-2 in the storage unit 161, and writes the result of this comparison (for example, “1” when the addresses match, and “0” when they do not match) in the storage unit 161 (step A11). The controller 162 refers to the comparison result and when the addresses match (step A11: Match), sets the temporary encryption key KEY-2 in the decoder 153 (step A12). When the counter 159 is operating (step A13: Yes), the counter 159 subtracts the packet size from the counter value (counter value T=counter value T-packet size), and proceeds to step A15. On the other hand, when the counter 159 is not operating (step A13: No), processing proceeds to step A15.

On the other hand, when the addresses do not match at step A11 (step A11: No match), the controller 162 determines whether the permanent encryption key KEY-1 is valid (step A17). If the permanent encryption key KEY-1 is valid (step A17: Yes), the controller 162 sets the permanent encryption key KEY-1 in the decoder 153 (step A18) and proceeds to step A15. When the permanent encryption key KEY-1 is not valid (step A17: No), the controller 162 stores the packet without change in the input/output buffer 154 (step A19).

At step A15, the decoder 153 decodes the data portion of the packet by using the set encryption key (the permanent encryption key KEY-1 or the temporary encryption key KEY-2), and stores the decoded packet in the input/output buffer 154 (step A16).

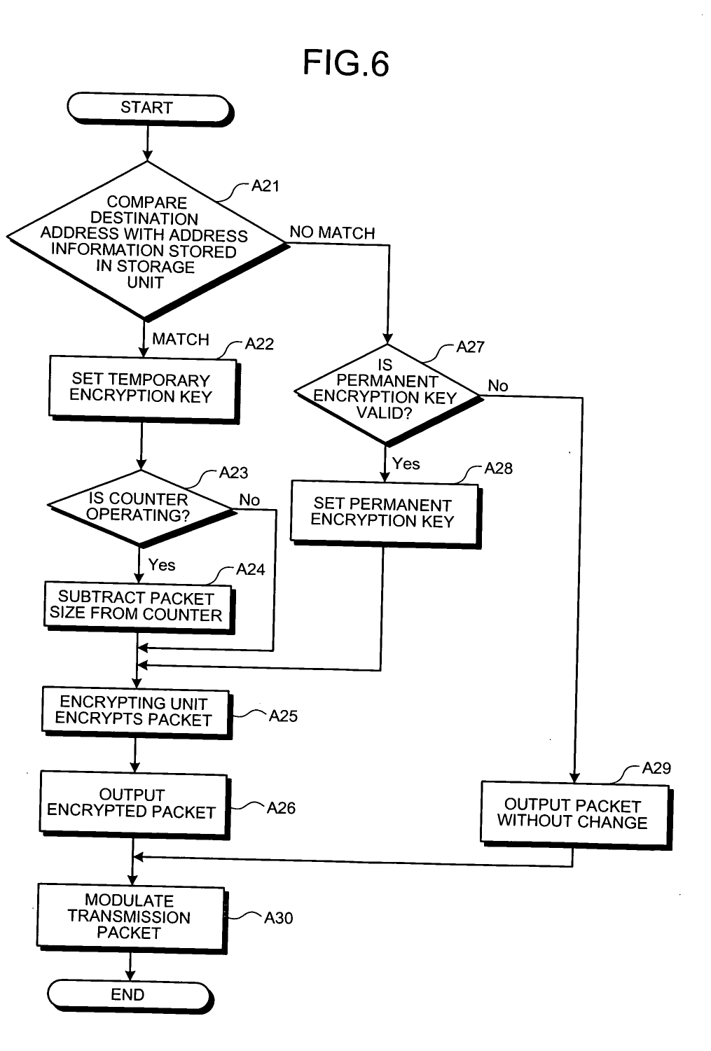

FIG. 6 is a flowchart of a process procedure performed by the base station 10 when transmitting a packet to the terminal station 20 or the terminal station 30. The operation when the base station 10 transmits a packet to the terminal station 20 or the terminal station 30 will be explained with reference to FIG. 6. The base station 10 transmits a packet to the terminal station 20 or the terminal station 30 in two different cases; when transmitting a packet received from a terminal station to a destination terminal station (relay), and when communicating only with the terminal station (for example, for authentication and the like).

In FIG. 6, at the base station 10, the destination address comparator 158 determines whether the destination address of the transmission packet stored in the input/output buffer 154 matches the address (terminal station address) that is stored in association with the temporary encryption key KEY-2 in the storage unit 161, and writes the result of this comparison (for example, “1” when the addresses match, and “0” when they do not match) in the storage unit 161 (step A21). The controller 162 refers to the comparison result and when the addresses match (step A21: Match), sets the temporary encryption key KEY-2 in the encrypting unit 155 (step A22). When the counter 159 is operating (step A23: Yes), the counter 159 subtracts the packet size of the transmission packet from the counter value (counter value T=counter value T-packet size), and proceeds to step A25. On the other hand, when the counter 159 is not operating (step A23: No), processing proceeds to step A25. On the other hand, when the addresses do not match at step A21 (step A21: No match), the controller 162 determines whether the permanent encryption key KEY-1 is valid (step A27). When the permanent encryption key KEY-1 is valid (step A27: Yes), the controller 162 sets the permanent encryption key KEY-1 in the encrypting unit 155 (step A28) and proceeds to step A25. When the permanent encryption key KEY-1 is not valid (step A27: No), the controller 162 outputs the packet without change to the modulator 156 (step A29) and proceeds to step A30. In this case, the packet passes without being encrypted by the encrypting unit 155.

At step A25, the encrypting unit 155 encrypts the data portion of the packet by using the set encryption key (the permanent encryption key KEY-1 or the temporary encryption key KEY-2), and outputs the encrypted packet to the modulator 156 (step A26). At step A30, the modulator 156 modulates the input transmission packet and transmits the modulated packet as a transmitted wave (step A30).

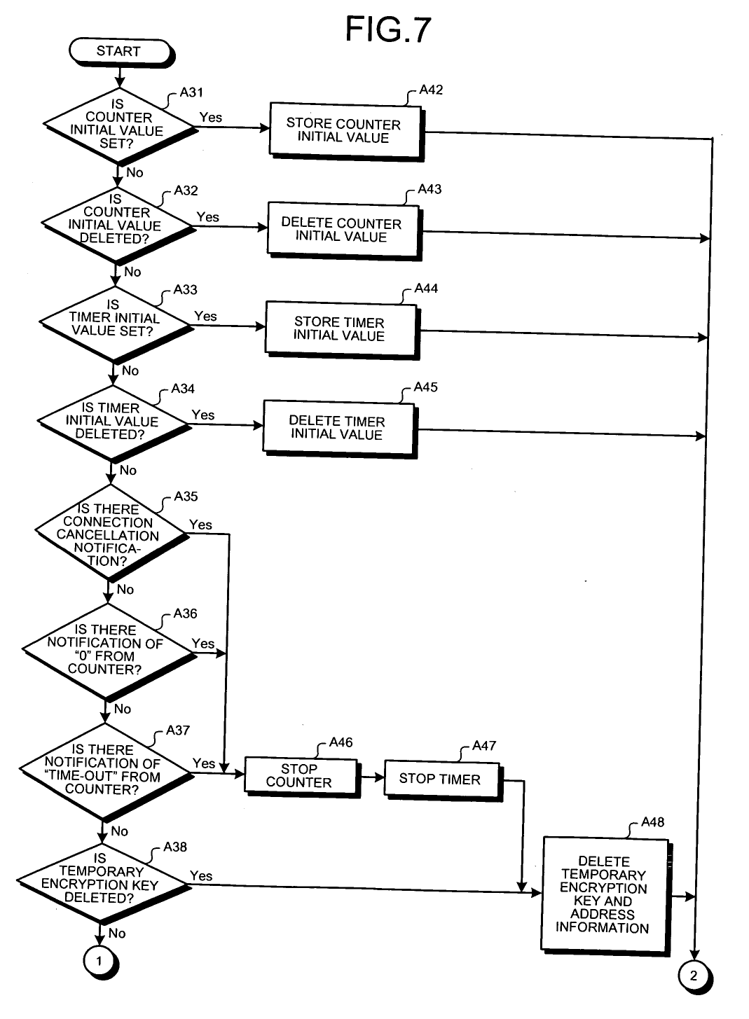

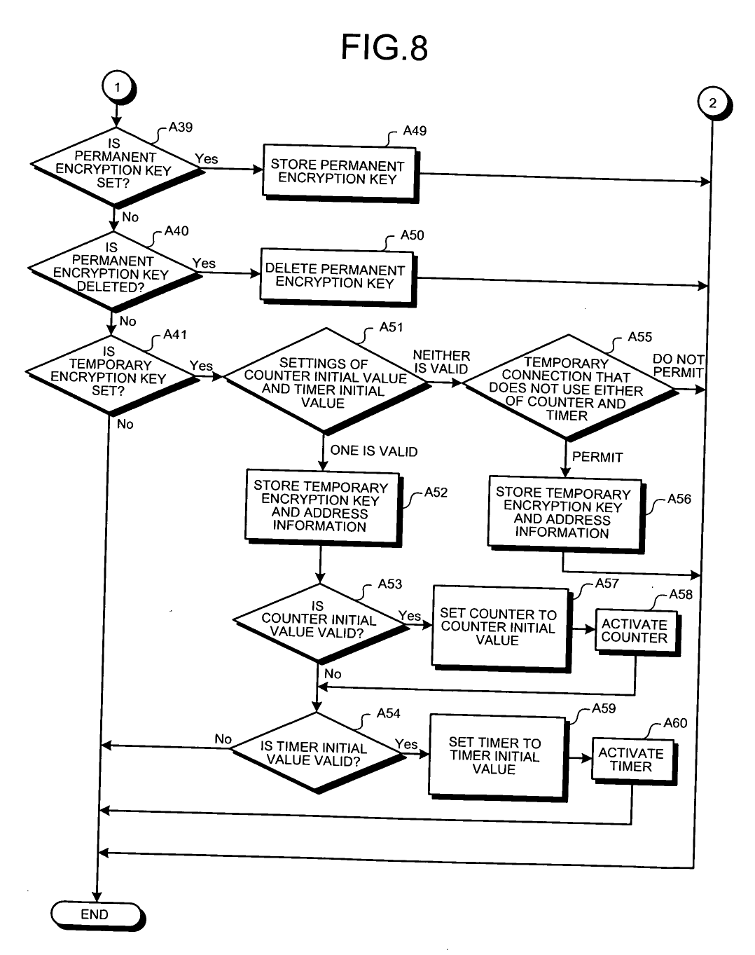

FIGS. 7 and 8 are flowcharts for explaining an operation of the controller 162 of the base station 10. In particular, these flowcharts are used for explaining an operation when there is a control input from the input device 104 and the external device, and a notification from the counter 159 and the timer 160.

In FIGS. 7 and 8, the controller 162 firstly determines whether a counter initial value has been set (step A31), and if the counter initial value has been set (step A31: Yes), stores the counter initial value in the storage unit 161 (step A42). If the counter initial value has not been set (step A31: No), the controller 162 determines whether the counter initial value has been deleted (step A32). If the counter initial value has been deleted (step A32: Yes), the controller 162 deletes the counter initial value from the storage unit 161 (step A43) If the counter initial value has not been deleted (step A32: No), the controller 162 determines whether a timer initial value has been set (step A33), and if the timer initial value has been set (step A33: Yes), stores the timer initial value in the storage unit 161 (step A44).

If the timer initial value has not been set (step A33: No), the controller 162 determines whether the timer initial value has been deleted (step A34). If the timer initial value has been deleted (step A34: Yes), the controller 162 deletes the timer initial value from the storage unit 161 (step A45).

If the timer initial value has not been deleted (step A34: No), the controller 162 determines whether there is a connection cancellation notification (step A35). If there is a connection cancellation notification (step A35: Yes), the controller 162 proceeds to step A46. If there is no connection cancellation notification (step A35: No), the controller 162 determines whether there is a notification of “0” from the counter 159 (step A36). If there is a notification of “0” from the counter 159 (step A36: Yes), the controller 162 proceeds to step A46. If there is no notification of “0” from the counter 159 (step A36: No), the controller 162 determines whether there is a notification of “time-out” from the timer 160 (step A37). If there is a notification of “time-out” from the timer 160 (step A37: Yes), the control proceeds to step A46. At step A46, the controller 162 stops the counter 159 and then stops the timer 160 (step A47). The controller 162 then deletes the temporary encryption key KEY-2 and address information from the storage unit 161 (step A48).

On the other hand, if there is no notification of “time-out” from the timer 160 (step A37: No), the controller 162 determines whether there is an instruction to delete the temporary encryption key KEY-2 (step A38). If there is an instruction to delete the temporary encryption key KEY-2 (step A38: Yes,), the controller 162 deletes the temporary encryption key KEY-2 and the address information from the storage unit 161 (step A48).

If there is no instruction to delete the temporary encryption key KEY-2 (step S38: No), the controller 162 determines whether the permanent encryption key KEY-1 is set (step A39). If the permanent encryption key KEY-1 is set (step A39: Yes), the controller 162 stores the permanent encryption key KEY-1 in the storage unit 161 (step A49). If there is no instruction to set the permanent encryption key KEY-1 (step A39: No), the controller 162 determines whether there is an instruction to delete the permanent encryption key KEY-1 (step A40). If there is an instruction to delete the permanent encryption key KEY-1 (step A40: Yes;), the controller 162 deletes the permanent encryption key KEY-1 from the storage unit 161 (step A50).

If there is no instruction to delete the permanent encryption key KEY-1 (step A40: No), the controller 162 determines whether the temporary encryption key KEY-2 has been set (step A41). If the temporary encryption key KEY-2 has been set (step A41: Yes), the controller 162 determines whether the setting of one of the counter initial value and the timer initial value is valid (step A51). If the setting of one of the counter initial value and the timer initial value is valid (step A51: One is valid), the controller 162 stores the temporary encryption key KEY-2 and the address information (terminal station address of the terminal station 30 where the temporary encryption key KEY-2 is set) in the storage unit 161 (step A52). The controller 162 then determines whether the counter initial value setting is valid (step A53), and if the counter initial value setting is not valid (step A53: No), proceeds to step A54. On the other hand, if the counter initial value setting is valid (step A53: Yes), the controller 162 sets the counter initial value stored in the storage unit 161 in the counter 159 (step A57), activates the counter 159 (step A58), and proceeds to step A54.

At step A54, the controller 162 determines whether the timer initial value setting is valid, and if the timer initial value setting is valid (step A54: Yes), sets the timer initial value stored in the storage unit 161 in the timer 160 (step A59), and activates the timer 160 (step A60). At step A51, if neither setting of the counter initial value and the timer initial value is valid (step A51: Neither is valid), the controller 162 determines whether to permit a temporary connection that does not use either of the counter 159 and the timer 160 (step A55). When permitting this, the controller 162 stores the temporary encryption key KEY-2 and the address information (terminal station address of the terminal station 30 where the temporary encryption key KEY-2 is set) in the storage unit 161 (step A56).

In this manner, in the first embodiment, the temporary encryption key KEY-2 is set in both the terminal station 30 and at the base station 10. Communications between the base station 10 and the terminal station 20 are performed by using the permanent encryption key KEY-1 (first common key) that can be used permanently unless it is modified, while communications between the base station 10 and the terminal station 30 are performed by using the temporary encryption key KEY-2. Therefore, security in the wireless LAN system can be maintained even when the terminal station 30 is connected thereto.

At the base station 10, when a set time (timer initial value) has elapsed after setting the temporary encryption key KEY-2, or when a set amount of communication data (counter initial value) has been transmitted, the temporary encryption key KEY-2 is deleted and rendered invalid. Therefore, use of the temporary encryption key KEY-2 can be restricted by using a simple configuration and method.

A wireless LAN system 2 according to a second embodiment of the present invention has the same configuration as the wireless LAN system 1. However, in the second embodiment, the base station 10 encrypts the temporary encryption key KEY-2 with the permanent encryption key KEY-1 and distributes the encrypted temporary encryption key KEY-3 to the terminal stations 20. The wireless LAN system of the second embodiment uses the IEEE 802.11 infrastructure mode.

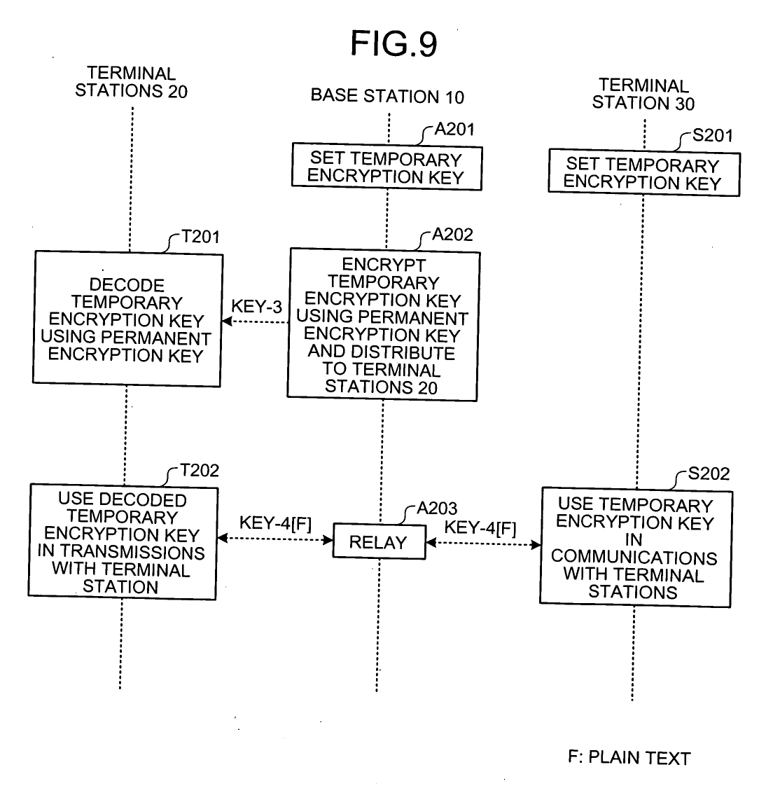

FIG. 9 is a flowchart of an example of a process procedure performed by a wireless LAN system 2 according to the second embodiment. When connecting the terminal station 30 to the wireless LAN system, the temporary encryption key KEY-2 is set in the terminal station 30 and the base station 10 (steps S201 and A201). When the temporary encryption key KEY-2 has been set, the base station 10 encrypts the temporary encryption key KEY-2 by using the permanent encryption key KEY-1 and distributes the obtained encrypted temporary encryption key KEY-3 to the terminal stations 20 (step A202). On the other hand, the terminal stations 20 decode the encrypted temporary encryption key KEY-3 by using the permanent encryption key KEY-1 stored in the storage unit 307, and store the decoded temporary encryption key KEY-4 in the storage unit 307 (step T201). Thereafter, communications between the terminal stations 20 and the terminal station 30 are executed using the decoded temporary encryption key KEY-4 (steps T202 and S202). In this case, the base station 10 only relays data (step A203). Communications between the terminal stations 20 are executed via the base station 10 by using the permanent encryption key KEY-1, which has not been shown in FIG. 9.

In this manner, in the second embodiment, the temporary encryption key KEY-2 is set in both the terminal station 30 and the base station 10. The base station 10 encrypts the temporary encryption key KEY-2 with the permanent encryption key KEY-1 and distributes the encrypted temporary encryption key KEY-3 to the terminal stations 20. The terminal stations 20 decode the encrypted temporary encryption key KEY-3 thereby obtaining the decoded temporary encryption key KEY-4. Communications between the terminal stations 20 and the terminal station 30 are performed by using the decoded temporary encryption key KEY-4. As a result, security can be maintained in the wireless LAN system 2 even if a terminal station is connected to it temporarily. Moreover, because the base station only relays the communications between the terminal stations 20 and the terminal station 30, the load on the base station 10 can be reduced drastically.

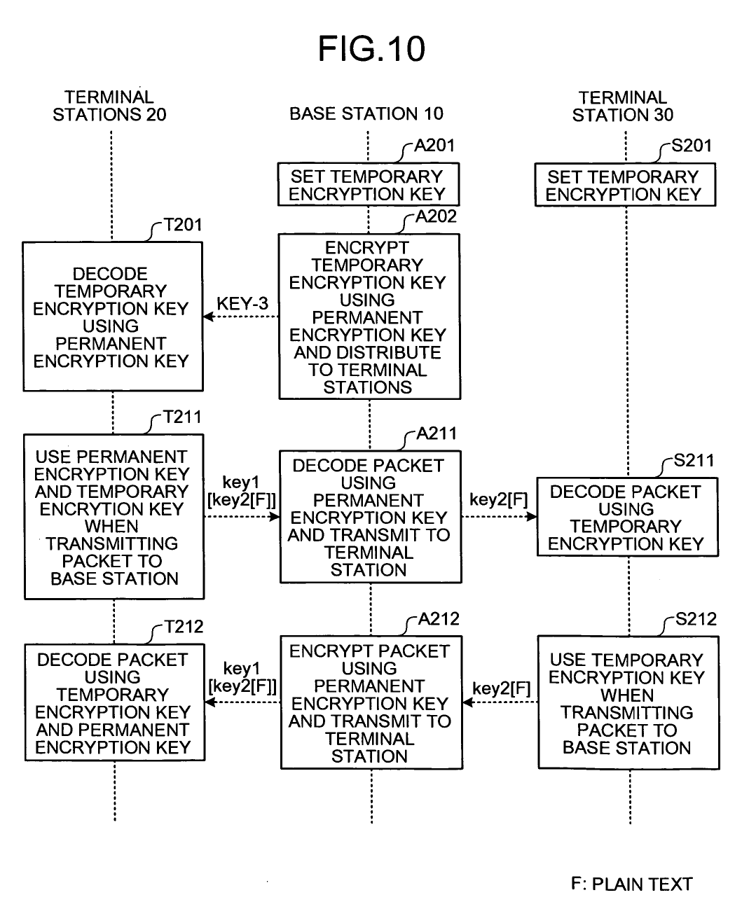

FIG. 10 is a flowchart of another example of a process procedure performed by the wireless LAN system 2. Like step numbers denote like processing steps as those in FIG. 9 and repetitious explanation thereof is omitted, and only different parts will be explained.

When transmitting a packet from a terminal station 20 to the terminal station 30, the base station 10 encrypts the temporary encryption key KEY-2 by using the permanent encryption key KEY-1 and distributes the encrypted temporary key KEY-3 to the terminal stations 20. The terminal stations 20 decode the encrypted temporary key KEY-3 and encrypt the packet using the decoded temporary encryption key KEY-4 and the permanent encryption key KEY-1 and transmit the encrypted packet to the base station 10 (step T211). Upon receiving such a packet, the base station 10 decodes the packet using the permanent encryption key KEY-1 (KEY-2[F]) and transmits the decoded packet to the terminal station 30 (step A211). The terminal station 30 uses the temporary encryption key KEY-2 to decode the received packet (step S211).

When transmitting a packet from the terminal station 30 to the terminal station 20, the terminal station 30 encrypts the packet by using the temporary encryption key KEY-2 (KEY-2[F]) and transmits the encrypted packet to the base station 10 (step S212). Upon receiving such a packet, the base station 10 further encrypts the packet using the permanent encryption key KEY-1 and transmits the encrypted packet to the terminal station 20 (step A212). The terminal station 20 uses the temporary encryption key KEY-2 and the permanent encryption key KEY-1 to decode the received packet (step T212).

In this manner, in this example, the temporary encryption key KEY-2 is set in both the terminal station 30 and the base station 10. The base station 10 then encrypts the temporary encryption key KEY-2 using the permanent encryption key KEY-1, and distributes the encrypted temporary encryption key KEY-3 to the terminal stations 20. In communications between the terminal stations 20 and the terminal station 30, communications between the base station 10 and the terminal stations 20 are performed by using the temporary encryption key KEY-2 and the permanent encryption key KEY-1, and communications between the base station 10 and the terminal station 30 are performed by using the temporary encryption key KEY-2. Therefore, security in the wireless LAN system can be maintained even if a terminal station is only temporarily connected to the wireless LAN system 2.

The base station 10 is configured to invalidate the temporary encryption key KEY-2 by deleting it if a predetermined time elapses after the temporary encryption key KEY-2 has been set in the base station 10, or when the volume of communications between the terminal stations 20 and terminal station 30 exceeds a predetermined value.

A wireless LAN system 3 according to a third embodiment of the present invention uses IEEE 802.11e direct link connection. The rest of the configuration is the same as that of the wireless LAN system 1.

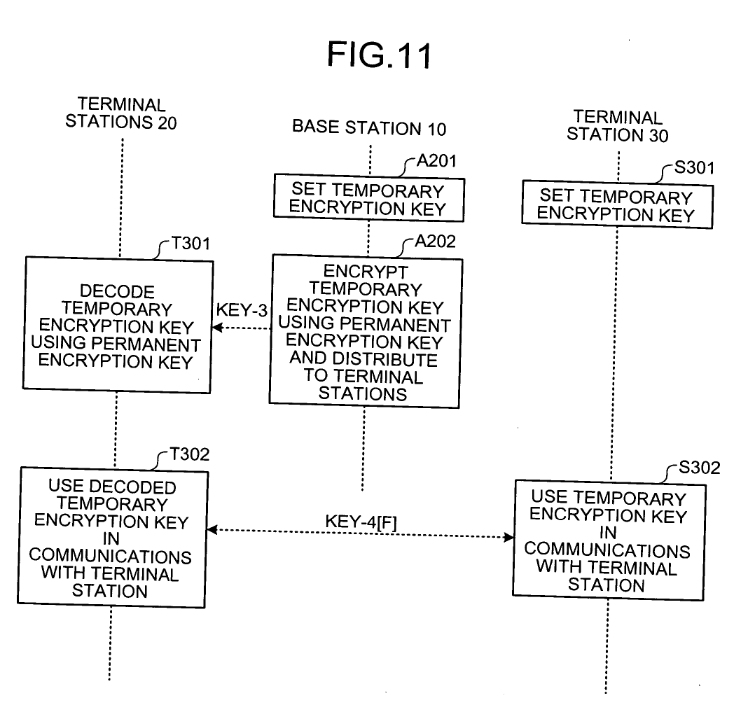

FIG. 11 is a flowchart of a process procedure performed by a wireless LAN system 3. When connecting the terminal station 30 to the wireless LAN system 3, the temporary encryption key KEY-2 (second common key) is set in both the terminal station 30 and the base station 10 (steps S301 and A201). The base station 10 encrypts the temporary encryption key KEY-2 with the permanent encryption key KEY-1 and distributes the encrypted temporary encryption key KEY-3 to the terminal stations 20 (step A202). The terminal stations 20 decode the encrypted temporary encryption key KEY-3 by using the permanent encryption key KEY-1 stored in the storage unit 307, and store the decoded temporary encryption key KEY-4 in the storage unit 307 (step T301).

Thereafter, communications between the terminal stations 20 and the terminal station 30 are directly performed by using the decoded temporary encryption key KEY-4 (steps T302 and S302). Thus, the base station 10 does not interfere with the communications between the terminal stations 20 and the terminal station 30. On the other hand, communications between the terminal stations 20 are performed directly by using the permanent encryption key KEY-1.

The terminal stations 20 and 30 are configured to invalidate the temporary encryption key KEY-2 by deleting it when a predetermined time elapses after the temporary encryption key KEY-2 has been set, or when the volume of communications between the terminal stations 20 and terminal station 30 exceeds a predetermined value.

In this manner, in the third embodiment, the temporary encryption key KEY-2 is set in both the terminal station 30 and the base station 10. The base station 10 encrypts the temporary encryption key KEY-2 with the permanent encryption key KEY-1 and distributes the encrypted temporary encryption key KEY-3 to the terminal stations 20. The terminal stations 20 decode the encrypted temporary encryption key KEY-3 thereby obtaining the decoded temporary encryption key KEY-4. Communications between the terminal stations 20 and the terminal station 30 are directly performed by using the decoded temporary encryption key KEY-4. As a result, security can be maintained in the wireless LAN system even if the terminal station 30 is connected to it temporarily. Moreover, because the base station 10 does not take part in the communications between the terminal stations 20 and the terminal station 30, the load on the base station 10 can be reduced drastically.

A wireless LAN system 4 according to a fourth embodiment will be explained. The wireless LAN system 4 according to the fourth embodiment is an example of a configuration that uses the IEEE 802.11 ad hoc mode. According to the IEEE 802.11 ad hoc mode, communications between terminal stations can be performed without relaying via the base station.

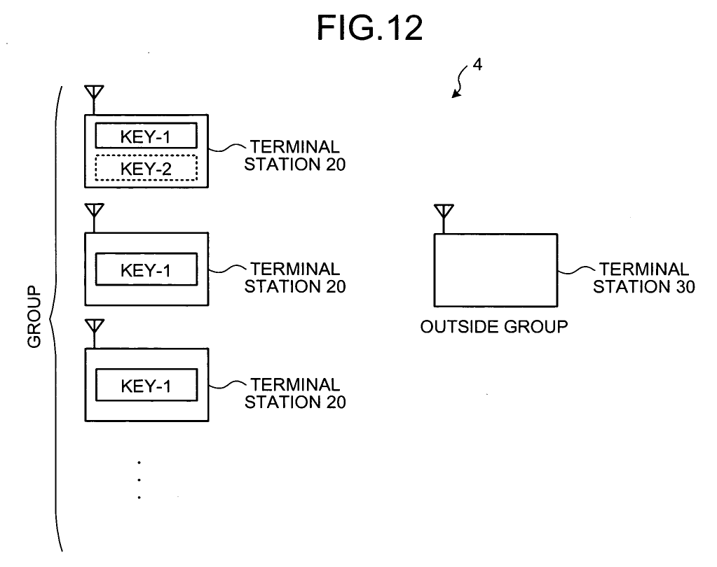

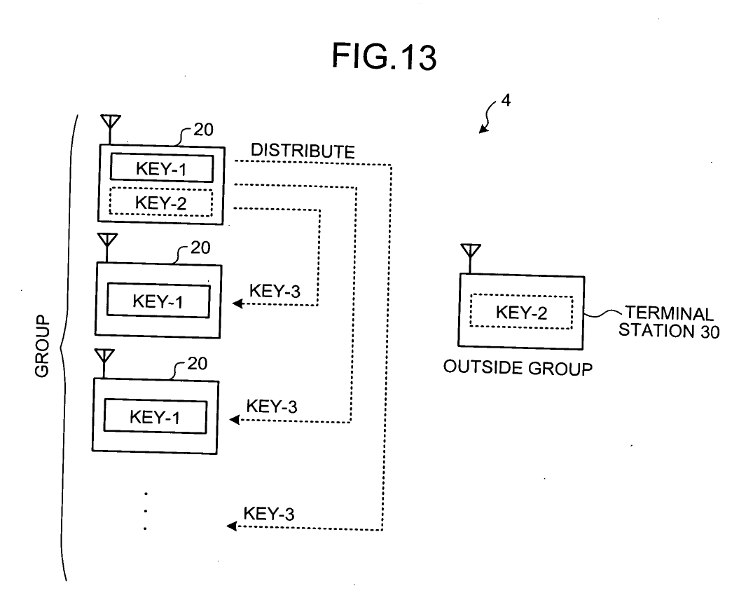

FIG. 12 is a schematic of the wireless LAN system 4. In the wireless LAN system 4, the permanent encryption key KEY-1 is set in advance in all the terminal stations 20, and the temporary encryption key KEY-2 is set in advance in any one of the terminal stations 20. FIG. 13 is a schematic for explaining an operation of the wireless LAN system 4. The temporary encryption key KEY-2 is set in the terminal station 30 and one of the terminal stations 20. The terminal station 20 in the temporary encryption key KEY-2 is set, encrypts the temporary encryption key KEY-2 using the permanent encryption key KEY-1 and distributes the encrypted temporary encryption key KEY-3 to other terminal stations 20. The other terminal stations 20 decode the encrypted temporary encryption key KEY-3 using the permanent encryption key KEY-1 that is stored in the storage unit 307, and store the decoded temporary encryption key KEY-4 in the storage unit 307. On the other hand, communications between the terminal stations 20 and the terminal station 30 are performed by using the temporary encryption key KEY-2. Communications between the terminal stations 20 are performed by using the permanent encryption key KEY-1.

The terminal stations 20 and 30 are configured to invalidate the temporary encryption key KEY-2 by deleting it when a predetermined time elapses after the temporary encryption key KEY-2 has been set, or when the volume of communications between the terminal stations 20 and terminal station 30 exceeds a predetermined value.

In this manner, according to the fourth embodiment, the temporary encryption key KEY-2 is set in the terminal station 30 and one of the terminal stations 20. The one terminal station 20 encrypts the temporary encryption key KEY-2 using the permanent encryption key KEY-1 and distributes the encrypted temporary encryption key KEY-3 to other terminal stations 20. The other terminal stations 20 decode the encrypted temporary encryption key KEY-3 to obtain a decoded temporary encryption key KEY-4. Communications between the terminal stations 20 and the terminal station 30 are directly performed by using the decoded temporary encryption key KEY-4. Therefore, security in the wireless LAN system can be maintained even when using a terminal station outside the group, and the system can be simplified since there is no need to distribute keys or perform communications via the base station.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wireless LAN system comprising:
a base station configured to store a first authentication information and a second authentication information;
at least one first terminal station configured to store the first authentication information; and
at least one second terminal station configured to store the second authentication information, wherein
the first terminal station is configured to perform wireless communications with another first terminal station via the base station based on the first authentication information, and
the first terminal station and the second terminal station are configured to perform wireless communications with each other via the base station based on the second authentication information.

2. The wireless LAN system according to claim 1, wherein
the base station encrypts the second authentication information by using the first authentication information thereby obtaining an encrypted second authentication information and sends the encrypted second authentication information to the first terminal station, and
the first terminal station and the second terminal station are configured to perform wireless communications with each other via the base station based on the second authentication information and the encrypted second authentication information.

3. The wireless LAN system according to claim 1, wherein
the base station encrypts the second authentication information by using the first authentication information thereby obtaining an encrypted second authentication information and sends the encrypted second authentication information to the first terminal station,
the first terminal station and the base station are configured to perform wireless communications with each other based on the first authentication information and the second authentication information, and
the base station and the second terminal station are configured to perform wireless communications with each other based on the second authentication information.

4. The wireless LAN system according to claim 1, wherein base station controls to make invalid the second authentication information stored therein and stored in the second terminal station.

5. The wireless LAN system according to claim 4, wherein base station makes invalid the second authentication information when a predetermined time has elapsed.

6. The wireless LAN system according to claim 4, wherein base station makes invalid the second authentication information when a volume of wireless communications between the base station and the second terminal station has exceeded a predetermined volume.

7. A wireless LAN system comprising:
a base station configured to store a first authentication information and a second authentication information, and to transmit a third authentication information prepared by encrypting the second authentication information with the first authentication information;
at least one first terminal station configured to receive and store the third authentication information; and
at least one second terminal station configured to store the second authentication information, wherein
the first terminal station is configured to perform wireless communications with another first terminal station directly based on the first authentication information, and
the first terminal station and the second terminal station are configured to perform wireless communications directly with each other based on the second authentication information and the third authentication information.

8. The wireless LAN system according to claim 7, wherein the base station makes invalid the second authentication information when a predetermined time has elapsed.

9. The wireless LAN system according to claim 7, wherein the base station makes invalid the second authentication information when a volume of wireless communications between the base station and the second terminal station has exceeded a predetermined volume.

10. A wireless LAN system comprising:
a first terminal station configured to store a first authentication information and a second authentication information, and to transmit a third authentication information prepared by encrypting the second authentication information with the first authentication information;
at least one second terminal station configured to store the second authentication information; and
at least one third terminal station configured to receive and store the third authentication information, wherein
the first terminal station is configured to perform wireless communications with the third terminal station based on the first authentication information, the first terminal station and the second terminal station are configured to perform wireless communications with each other based on the second authentication information, and
the second terminal station and the third terminal station are configured to perform wireless communications with each other based on the second authentication information and the third authentication information.

11. The wireless LAN system according to claim 10, wherein the terminal station makes invalid the second authentication information when a predetermined time has elapsed.

12. The wireless LAN system according to claim 10, wherein the terminal station makes invalid the second authentication information when a volume of wireless communications with the second terminal station has exceeded a predetermined volume.

13. A base station that performs wireless communications with a plurality of terminal stations including at least one first terminal station and at least one second terminal station, the base station comprising:
a storing unit configured to store therein a first authentication information and a second authentication information; and
a communications unit configured to perform wireless communications with the first terminal station based on the first authentication information, and to perform wireless communications with the second terminal station based on the second authentication information.

14. The base station according to claim 13, wherein the communications unit
encrypts the second authentication information by using the first authentication information thereby obtaining an encrypted second authentication information and sends the encrypted second authentication information to the first terminal station, and
relays wireless communications between the first terminal station and the second terminal station based on the second authentication information.

15. The base station according to claim 13, wherein the communications unit
encrypts the second authentication information by using the first authentication information thereby obtaining an encrypted second authentication information and sends the encrypted second authentication information to the first terminal station,
performs wireless communications with the first terminal station based on the first authentication information and the second authentication information, and
performs wireless communications with the second terminal station based on the second authentication information.

16. The base station according to claim 13, further comprising an invalidating unit configured to make invalid the second authentication information.

17. The base station according to claim 16, wherein the invalidating unit makes invalid the second authentication information when a predetermined time has elapsed.

18. The base station according to claim 16, wherein the invalidating unit makes invalid the second authentication information when a volume of wireless communications between the base station and the second terminal station has exceeded a predetermined volume.
